(19) United States
(12) Patent Application Publication
(10) Pub. No.: US 2026/0241710 A1
(43) Pub. Date: Aug. 20, 2026

(54) PRINTING DEVICE

(71) Applicant: SEIKO EPSON CORPORATION, Tokyo (JP)

(72) Inventors: Ryuji MORIYAMA, MATSUMOTO-SHI (JP); Hiroki SHINAGAWA, SHIOJIRI-SHI (JP); Yuta WATANABE, MATSUMOTO-SHI (JP); Kazuma OZAKI, OKAYA-SHI (JP)

(21) Appl. No.: 19/541,538

(22) Filed: Feb. 17, 2026

(30) Foreign Application Priority Data
Feb. 20, 2025 (JP) 2025-025613

(51) Int. Cl. B41J 11/00

(52) U.S. Cl. CPC B41J 11/00214; B41J 11/00212; B41J 11/00218

(57) ABSTRACT

A printing device includes a head that ejects a liquid that is cured with an electromagnetic wave, a carriage that supports the head and is movable in a scanning direction, a moving unit configured to move the carriage in an intersecting direction, an electromagnetic wave irradiation unit that is installed in the carriage and displaceable to a first relative position and a second relative position along the intersecting direction with respect to the head, a main-body-side abutment part that displaces the electromagnetic wave irradiation unit to any one of the first and the second relative position, a drive unit that moves the moving unit along the intersecting direction; and a control unit that controls the drive unit. The control unit determines that the electromagnetic wave irradiation unit is located at the first relative position or the second relative position, due to a load fluctuation in the drive unit.

### CROSS REFERENCE TO RELATED APPLICATION

The present application is based on, and claims priority from JP Application Serial Number 2025-025613, filed February 20, 2025, the disclosure of which is hereby incorporated by reference herein in its entirety.

### BACKGROUND

### 1. Technical Field

The present disclosure relates to a printing device.

### 2. Related Art

JP-A-2024-2022 discloses a printing device that emits ultraviolet rays from an irradiation unit installed in a carriage and thus cures ink and in which the structures of the device emitting ultraviolet rays and the carriage are simplified. This printing device includes a carriage including a head movable in a first direction along a first axis and an irradiation unit relatively movable in a second direction along a second axis intersecting the first axis, and a control unit. The irradiation unit includes a first irradiator group and a second irradiator group arranged in the second direction, and the first irradiator group is disposed at a position overlapping a plurality of nozzles in the first direction, and the second irradiator group is disposed at a position not overlapping the plurality of nozzles in the first direction. The control unit is configured to be able to execute a first mode in which the first irradiator group and the second irradiator group emit ultraviolet rays, and a second mode in which the first irradiator group does not emit ultraviolet rays and the second irradiator group emits ultraviolet rays.

JP-A-2024-2022 is an example of the related art.

In the printing device as disclosed in JP-A-2024-2022, the irradiation unit moves along the second axis as the carriage moves in a state in which an electromagnetic wave irradiation unit that emits electromagnetic waves such as ultraviolet rays abuts against a main-body-side abutment part provided in the main body of the printing device.

However, in the printing device as disclosed in JP-A-2024-2022, it may be difficult to determine whether the electromagnetic wave irradiation unit formed to be movable moves to a predetermined position.

### SUMMARY

According to an aspect of the present disclosure, a printing device includes: a head that ejects a liquid which is cured when irradiated with an electromagnetic wave; a carriage that supports the head and is movable in a scanning direction; a moving unit configured to be able to move the carriage in an intersecting direction intersecting the scanning direction; an electromagnetic wave irradiation unit that is installed in the carriage in a state of being displaceable to a first relative position and a second relative position along the intersecting direction with respect to the head and emits the electromagnetic wave; a main-body-side abutment part that displaces the electromagnetic wave irradiation unit to any one of the first relative position and the second relative position by coming into contact with the electromagnetic wave irradiation unit; a drive unit that moves the moving unit along the intersecting direction; and a control unit that controls the drive unit, and the control unit determines that the electromagnetic wave irradiation unit is located at the first relative position or the second relative position, due to a load fluctuation in the drive unit.

### BRIEF DESCRIPTION OF THE DRAWINGS

FIG. 1 is a perspective view of a printing device according to an embodiment of the present disclosure.

FIG. 2 is a plan view of a carriage.

FIG. 3 is a perspective view of an irradiation unit.

FIG. 4 is a perspective view of a main part of the carriage.

FIG. 5 is a perspective view of a main part of the printing device.

FIG. 6 is a plan view of the carriage.

FIG. 7 is a block diagram of the printing device.

FIG. 8 is a flowchart of the operation of the printing device.

### DESCRIPTION OF EMBODIMENTS

An embodiment of the present disclosure will now be described with reference to the drawings.

In each drawing, a reference sign FR indicates a forward direction in relation to a printing device 1 in a state of being installed on an installation surface and used normally, a reference sign UP indicates an upward direction in relation to the printing device 1, and a reference sign LH indicates a leftward direction in relation to the printing device. A front-rear direction and a left-right direction of the printing device 1 coincide with the horizontal direction, and an up-down direction coincides with the vertical direction. In the description below, each direction is a direction along these directions in relation to the printing device 1.

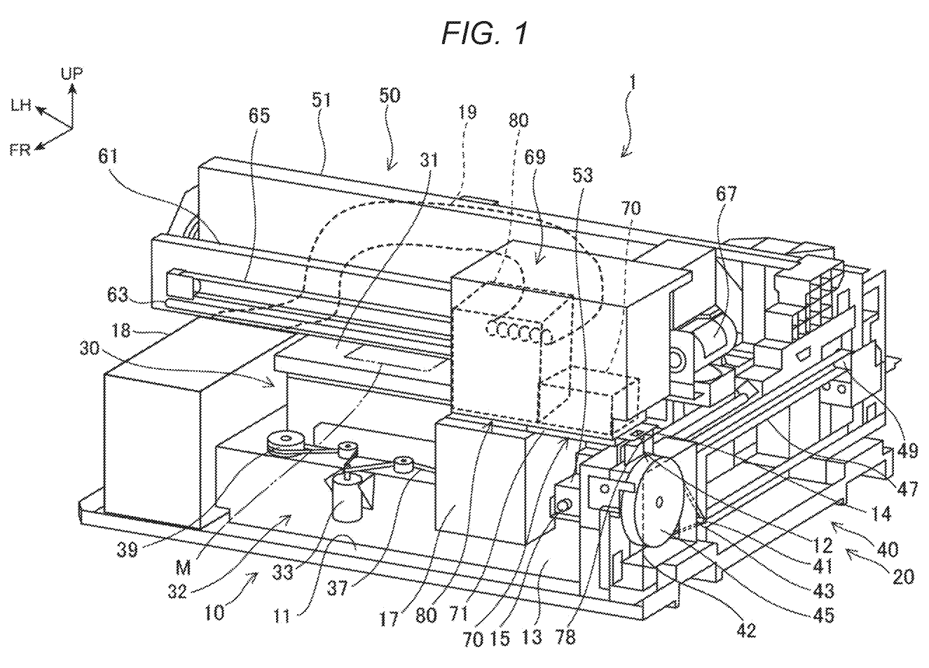

FIG. 1 is a perspective view illustrating the printing device 1 according to an embodiment of the present disclosure.

The printing device 1 illustrated in FIG. 1 is a device that performs printing by ejecting ink onto a medium M placed on a table 31 and curing the ink attached to the medium M by irradiating the medium M with ultraviolet rays. Examples of the medium M include a sheet, a cloth, and a three-dimensional object. The sheet may be a sheet of paper or synthetic resin. The cloth may be any one of a nonwoven fabric, a knitted cloth, and a fabric. The three-dimensional object includes clothing items such as clothes and shoes, daily necessities, mechanical components, and other various objects.

The printing device 1 includes the table 31 supporting the medium M. The table 31 is a table that does not move in the front-rear direction and the left-right direction. The table 31 supports the medium M at a flat upper surface thereof.

In the printing device 1, the table 31 supports the medium M so that the medium M does not move, and a carriage 69 scans above the medium M supported by the table. In the carriage 69, a head 80 and an irradiation unit 70, described later, are installed side by side in the left-right direction, and ink is ejected from the head 80 toward the medium M and subsequently the ink attached to the medium M is irradiated with ultraviolet rays from the irradiation unit 70.

The printing device 1 includes a main body unit 10 and a moving unit 50. The main body unit 10 is a pedestal fixed to an installation surface of the printing device 1. The moving unit 50 moves in the front-rear direction with respect to the main body unit 10.

The main body unit 10 includes a bottom plate 11, a base part 13, a medium support mechanism 30, and a drive mechanism 20. The bottom plate 11 is a plate-shaped member fixed to the installation surface of the printing device 1. The base part 13 is supported on the upper surface of the bottom plate 11 and supports each part of the printing device 1.

The medium support mechanism 30 includes the table 31 and a height movement mechanism 32. The table 31 includes a rectangular flat plate as an upper surface, and leg parts disposed at the four corners of the flat plate and extending downward from the flat plate.

The height movement mechanism 32 includes a lifting and lowering motor 33, a lifting and lowering belt 37, and a lifting and lowering mechanism 39, and moves the table 31 in the up-down direction. The lifting and lowering mechanism 39 is provided for each of the four leg parts of the table 31. The lifting and lowering mechanism 39 includes a ball screw arranged to extend along the up-down direction, a nut screwed with the ball screw, and a pulley. The ball screw of the lifting and lowering mechanism 39 is rotatably supported by the base part 13. The nut of the lifting and lowering mechanism 39 is fixed to the leg part of the table 31. The pulley of the lifting and lowering mechanism 39 is fixed to an upper part of the ball screw. When the pulley of the lifting and lowering mechanism 39 rotates, the ball screw rotates, and the table moves in the up-down direction together with the nut due to the rotation of the ball screw.

The lifting and lowering motor 33 is a motor that rotates under the control of a control unit 90, described later. The control unit 90 controls the direction of rotation and the amount of rotation of the lifting and lowering motor 33. The lifting and lowering belt 37 is an annular belt laid over the output shaft of the lifting and lowering motor 33 and pulleys of the four lifting and lowering mechanisms 39. As the lifting and lowering motor 33 rotates, the lifting and lowering belt 37 is driven to circulate. The lifting and lowering belt 37 transmits the rotation of the lifting and lowering motor 33 to the pulleys of the four lifting and lowering mechanisms 39. As the lifting and lowering belt 37 rotates the pulleys of the four lifting and lowering mechanisms 39, the ball screws of the four lifting and lowering mechanisms 39 synchronously rotate and the entire table 31 moves in the up-down direction. Also, in the printing device 1, the pulley of a predetermined lifting and lowering mechanism 39 may be rotated in a state where the lifting and lowering belt 37 is not laid thereon, and the ball screw may thus be individually rotated and only a part of the leg parts of the table 31 may be moved in the up-down direction. In this case, in the printing device 1, the inclination of the table 31 is adjusted by individually moving a part of the leg parts in the up-down direction.

The direction of rotation of the lifting and lowering motor 33 can be switched between a forward direction in which the table 31 is moved upward and a reverse direction in which the table 31 is moved downward. In the printing device 1, the table 31 is lifted and lowered by causing the lifting and lowering motor 33 to operate.

In the printing device 1, as the height of the table 31 is changed in this manner, the distance between a nozzle 83 of the head 80, described later, and the medium M, is adjusted to be an optimal distance for printing.

The drive mechanism 20 includes a guide shaft 15 and a frame drive unit 40. The guide shaft 15 is a long shaft-like member placed at a right end part of the base part 13 and disposed such that the longitudinal direction thereof extends along the front-rear direction.

The direction in which the guide shaft 15 extends, that is, the front-rear direction, is an example of an "intersecting direction".

The main body unit 10 is provided with ink container unit 18. The ink container unit 18 is placed on the bottom plate 11 and is disposed at a front end part and a left end part of the main body unit 10. The ink container unit 18 contains a plurality of ink cartridges. Inks of cyan, magenta, yellow, black, and the like are stored in the ink cartridges.

The moving unit 50 includes a main frame 51 and frame leg parts 53.

The main frame 51 is a long plate-shaped member whose longitudinal direction extends in the left-right direction. The frame leg parts 53 are supported by the guide shafts 15 so as to be movable in the front-rear direction. A right end part of the main frame 51 is fixed to the top of the frame leg part 53 and is supported from below by the frame leg part 53. The main frame 51, together with the frame leg part 53, is guided by the guide shaft 15 and moves in the front-rear direction.

The frame drive unit 40 includes a frame moving motor 41, a transmission belt 43, a transmission mechanism 45, and a transmission belt 47.

The frame moving motor 41 is a motor that rotates under the control of the control unit 90, described later. The transmission belt 43 is an annular belt laid between the output shaft of the frame moving motor 41 and the transmission mechanism 45, and transmits the driving force of the frame moving motor 41 to the transmission mechanism 45. The transmission mechanism 45 includes a first pulley and a second pulley, and the transmission belt 43 is wound around the first pulley, and the transmission belt 47 is wound around the second pulley. The transmission mechanism 45 rotates the second pulley with the driving force transmitted from the transmission belt 43 to the first pulley, and thus drives the transmission belt 47. The transmission mechanism 45 transmits the driving force of the frame moving motor 41 to the transmission belt 47 at a reduction ratio corresponding to the ratio of the diameters of the first pulley and the second pulley.

The frame moving motor 41 is an example of a "drive unit".

The transmission belt 47 is an annular belt laid over the transmission mechanism 45 and a pulley 49 disposed at a right end part of the base part 13. The pulley 49 is rotatably installed with respect to the base part 13. The transmission belt 47 is disposed to extend along the front-rear direction when viewed in a plan view. The frame leg part 53 is fixed to the transmission belt 47. Therefore, when the transmission belt 47 is driven to circulate, power for moving the frame leg part 53 along the front-rear direction is transmitted and the moving unit 50 moves in the front-rear direction.

The direction of rotation of the frame moving motor 41 can be switched between a forward direction in which the main frame 51 is moved forward and a reverse direction in which the main frame 51 is moved backward. In the printing device 1, the main frame 51 is moved forward and backward by operating the frame moving motor 41.

The transmission mechanism 45 is accommodated inside a box-shaped accommodation body 42. The accommodation body 42 is placed on the bottom plate 11 and is disposed at a front end part and a right end part of the main body unit 10. The accommodation body 42 is disposed to the right of the guide shaft 15 when viewed in a front view or a plan view.

An abutment member 12 is provided at an upper part of the accommodation body 42. The abutment member 12 is, for example, a plate-shaped member such as a metal plate. The abutment member 12 does not overlap the table 31 in the front-rear direction and does not overlap the table 31 in the left-right direction, and is located diagonally to the right of the table 31.

The abutment member 12 may not be provided in the accommodation body 42 as long as the abutment member 12 is disposed at the front end part and the right end part of the main body unit 10 and is disposed to the right of the guide shaft 15 when viewed in a front view or a plan view.

A carriage support frame 61, a carriage guide shaft 63, a carriage drive motor 67, and the carriage 69 are attached to the main frame 51. The carriage 69 includes the head 80 and the irradiation unit 70, described later.

The carriage support frame 61 is a long plate-shaped member whose longitudinal direction extends in the left-right direction. The carriage guide shaft 63 is fixed to the carriage support frame 61 such that the longitudinal direction of the carriage guide shaft 63 is along the left-right direction. The carriage 69 is supported by the carriage support frame 61 and the carriage guide shaft 63 and is movable along the carriage guide shaft 63. In a range in which the carriage 69 moves along the left-right direction, a right end position is defined as a home position. The main body unit 10 includes a cleaner 17 that performs maintenance such as flushing and cleaning of the head 80, at the home position. In FIG. 1, the carriage 69 is located at the home position.

The direction in which the carriage guide shaft 63 extends, that is, the left-right direction, is an example of a "scanning direction".

The carriage drive motor 67 is a motor that rotates under the control of the control unit 90, described later. The rotation of the carriage drive motor 67 is transmitted to a carriage drive belt 65, and the carriage drive belt 65 is driven to circulate.

The carriage drive belt 65 is an annular belt laid along the left-right direction over the carriage support frame 61. The carriage 69 is coupled to the carriage drive belt 65. Therefore, when the carriage drive belt 65 is driven to circulate, the carriage 69 moves along the left-right direction. When the main frame 51 moves along the front-rear direction, the carriage 69 moves in the front-rear direction. Therefore, in the printing device 1, the carriage 69 can move in the front-rear direction and the left-right direction.

As described above, the head 80 is installed in the carriage 69. Thus, in the printing device 1, the head 80 can move in the front-rear direction and the left-right direction with respect to the table 31. Therefore, in the printing device 1, ink can be ejected onto the entire medium M supported by the table 31. As described above, the carriage 69 is equipped with the irradiation unit 70. Therefore, in the printing device 1, the irradiation unit 70 can move in the front-rear direction and the left-right direction.

### 1.2. Configuration of Carriage

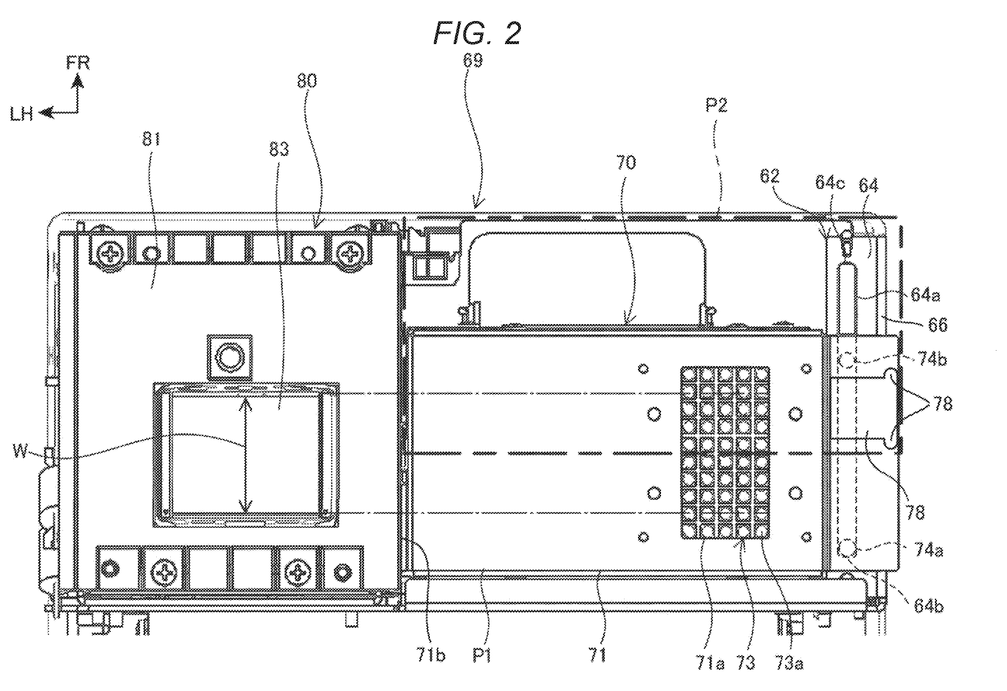

FIG. 2 is a plan view of the carriage 69 as viewed from below.

As illustrated in FIG. 2, the carriage 69 includes the head 80, the irradiation unit 70, and a guide 62. In the carriage 69, the head 80 and the irradiation unit 70 are installed side by side in the left-right direction.

The head 80 is a device that drives a piezoelectric actuator to eject ink. The head 80 is fixed to the carriage 69 and is thus disposed on the left side of the carriage 69. A bottom panel 81 is provided below the head 80. The bottom panel 81 is a substantially rectangular plate that is provided horizontally, and has a rectangular opening at the center. The nozzle 83 provided in the head 80 is exposed from the opening of the bottom panel 81. The nozzle 83 includes a large number of fine holes that open downward, and ejects ink from the holes and thus attaches the ink to the medium M.

As shown in FIG. 1, the head 80 is coupled to each of the ink cartridges contained in the ink container unit 18 via each of a plurality of ink tubes 19. One end part of each of the ink tubes 19 is coupled to each of the ink cartridges, and each of the ink tubes 19 extends from the rear surface of the ink container unit 18, passes below the main frame 51 and the carriage support frame 61, and is routed to the rear of the main frame 51. An intermediate part of each of the ink tubes 19 routed to the rear of the main frame 51 is fixed to the back surface of the main frame 51. Each of the ink tubes 19 is routed from the part fixed to the back surface of the main frame 51 to the front of the main frame 51 and the carriage support frame 61, and the other end part thereof is coupled to the head 80.

In the printing device 1, when the main frame 51 is guided by the guide shaft 15 and moves forward, the bent part of each of the routed ink tubes 19 extends. Meanwhile, in the printing device 1, when the main frame 51 is guided by the guide shaft 15 and moves rearward, each of the routed ink tubes 19 is bent so as to be folded.

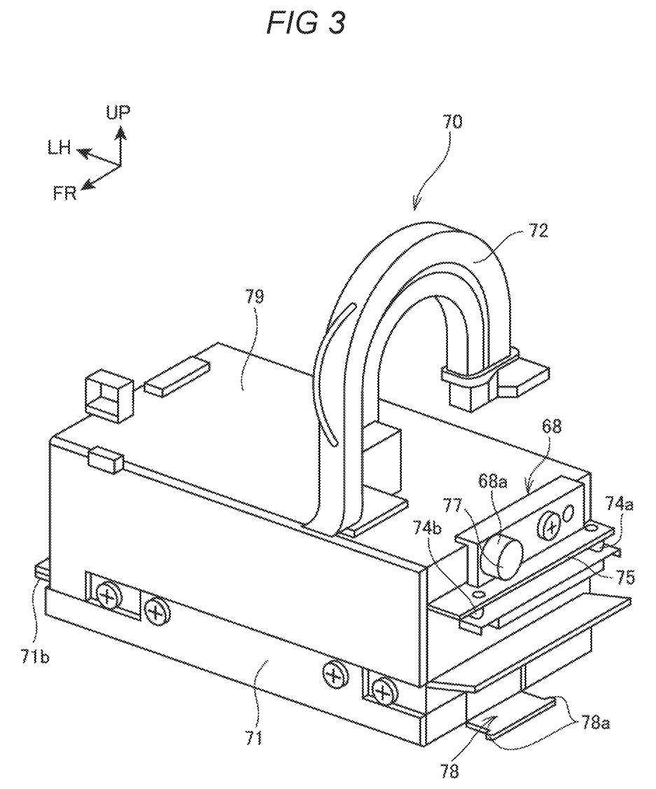

FIG. 3 is a perspective view of the irradiation unit 70.

As illustrated in FIG. 2, the irradiation unit 70 is disposed at a position close to the right side of the head 80 in the carriage 69. As illustrated in FIG. 3, the irradiation unit 70 includes a case 79, which is an exterior member covering an upper part of the irradiation unit 70, and a housing 71, which is an exterior member covering a lower part of the irradiation unit 70.

As illustrated in FIG. 2, the irradiation unit 70 includes an irradiation port 71a in the lower surface thereof. The irradiation port 71a is a rectangular hole formed by opening the housing 71. The irradiation port 71a is covered with plate glass from inside the housing 71. The medium M placed below the housing 71 is irradiated with ultraviolet rays emitted from a UV light source 73 provided inside the housing 71 via the plate glass and the irradiation port 71a. The UV light source 73 is formed by arranging light emitting elements 73a emitting ultraviolet rays, in the left-right direction and the front-rear direction. The light emitting element 73a is, for example, an ultraviolet light emitting diode (UV-LED).

The irradiation unit 70 is not limited to emitting ultraviolet rays and may be formed to be able to emit any electromagnetic wave according to the material used for the ink. The irradiation unit 70 may be formed to be able to emit, for example, infrared rays, electron beams, various visible rays, or the like.

The irradiation unit 70 is an example of an "electromagnetic wave irradiation unit".

At the upper surface of the housing 71, a wiring unit 72 in which power supply lines for supplying power to the UV light sources 73 and various signal lines are gathered together extends outward.

As shown in FIGS. 2 and 3, a sliding member 71b is provided at a left end part of the housing 71. The sliding member 71b is a member attached to the edge of the left end part of the housing 71. The sliding member 71b bulges downward from the edge of the left end part. The sliding member 71b is in contact with a right end part of the upper surface of the bottom panel 81 of the head 80 from above. Thus, the left end part of the irradiation unit 70 is supported by the bottom panel 81 so as to be movable relative to the carriage 69 in the front-rear direction.

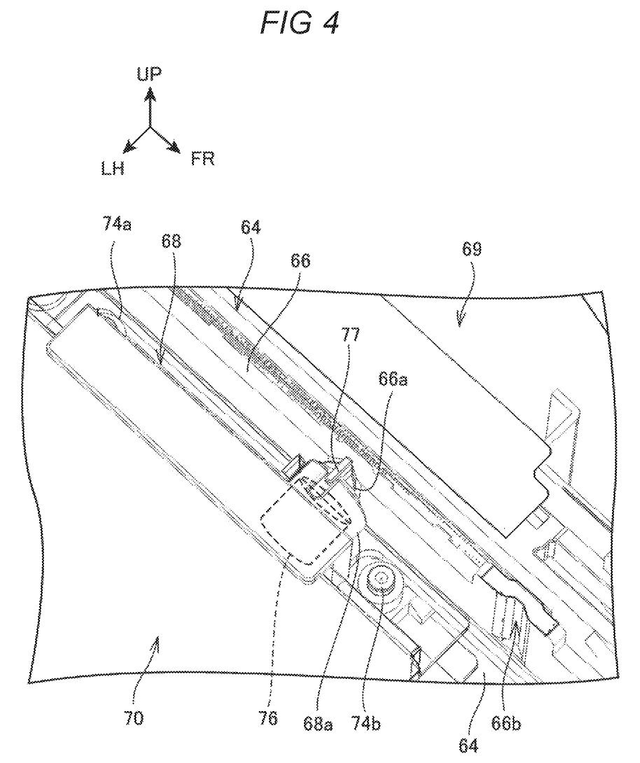

FIG. 4 is a perspective view illustrating the guide 62 attached to the carriage 69.

As shown in FIGS. 2 and 4, the guide 62 is a member fixed to the carriage 69 with the longitudinal direction of the guide 62 laid in the front-rear direction. The guide 62 is provided at a right end part of the carriage 69. The guide 62 is an L-shaped member when viewed in a front view, and includes a flat plate-shaped guide part 64 that is provided horizontally, and a flat plate-shaped holding part 66 rising vertically from an end part located to the right of the guide part 64.

A guide hole 64a, which is a substantially rectangular hole extending in the front-rear direction, is formed in the guide part 64. A first recess 66a and a second recess 66b are formed on a left-facing surface of the holding part 66. Each of the first recess 66a and the second recess 66b is formed in a recessed shape depressed to the right. The first recess 66a is formed near the center of the holding part 66, and the second recess 66b is formed to the front of the first recess 66a.

The first recess 66a and the second recess 66b are examples of a "recess".

As shown in FIG. 3, in the irradiation unit 70, a coupling part 75 protruding to the right is provided at a side surface located on the right side of the case 79. In the present embodiment, the coupling part 75 is formed in the shape of a flat plate whose plate thickness direction coincides with the up-down direction, and the longitudinal direction thereof extends over substantially the entire right side surface of the case 79 in the front-rear direction. The coupling part 75 includes a first guide pin 74a and a second guide pin 74b. The first guide pin 74a and the second guide pin 74b each have a shape of a pin protruding downward, and are arranged side by side in the front-rear direction. The first guide pin 74a and the second guide pin 74b are inserted into the guide hole 64a of the guide 62. Thus, the irradiation unit 70 is supported by the guide 62 at the right end part so as to be movable relative to the carriage 69 in the front-rear direction.

As illustrated in FIGS. 3 and 4, in the irradiation unit 70, a positioning part 68 is provided at a side surface located on the right side of the case 79. The positioning part 68 includes a tubular part 68a extending to the right from the right side surface of the case 79 and having a distal end part facing the left-facing surface of the holding part 66. A coil spring 76 is housed inside the tubular part 68a. The coil spring 76 is disposed inside the tubular part 68a so as to be compressible in the left-right direction.

Also, a pressing part 77 is housed inside the tubular part 68a. The pressing part 77 is formed in the shape of a pin or a ball that can be fitted in each of the first recess 66a and the second recess 66b.

As the pressing part 77 is energized by the coil spring 76, a part of the pressing part 77 protrudes outward from the right end part of the tubular part 68a and abuts against the left-facing surface of the holding part 66. In this way, the positioning part 68 functions as a plunger.

The pressing part 77 is an example of a "protrusion".

When the irradiation unit 70 moves relative to the carriage 69 in the front-rear direction along the guide 62, the pressing part 77 moves in the front-rear direction in a state of abutting against the left-facing surface of the holding part 66. When the pressing part 77 is disposed at a position overlapping either the first recess 66a or the second recess 66b when viewed in the left-right direction, the pressing part 77 is energized by the coil spring 76 and is fitted into the first recess 66a or the second recess 66b.

When the pressing part 77 is fitted in either the first recess 66a or the second recess 66b, the relative movement of the irradiation unit 70 with respect to the carriage 69 is suppressed by the energizing force of the coil spring 76, and the irradiation unit 70 is positioned.

When the irradiation unit 70 is pressed along the front-rear direction by a force exceeding the energizing force of the coil spring 76, the pressing part 77 is released from either the first recess 66a or the second recess 66b, and the irradiation unit 70 moves relative to the carriage 69 in the front-rear direction. As described above, the coil spring 76 is compressible along the left-right direction. Therefore, the pressing force required for moving the irradiation unit 70 forward is substantially the same as the pressing force required for moving the irradiation unit 70 rearward.

In this way, the irradiation unit 70 is supported by the guide 62 and the bottom panel 81 at both left and right end parts so as to be movable relative to the head 80 in the front-rear direction.

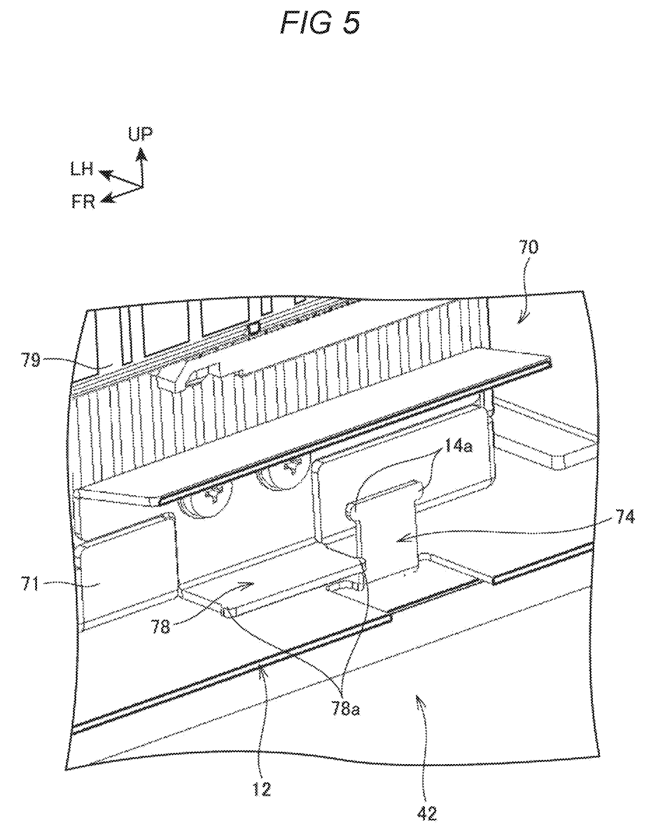

FIG. 5 is a perspective view of a main part of the printing device 1. FIG. 5 shows a moving-side abutment part 78 in a state where the carriage 69 is located at the home position.

As illustrated in FIGS. 2, 4, and 5, in the irradiation unit 70, the moving-side abutment part 78 is provided at a side surface located on the right side of the housing 71. The moving-side abutment part 78 extends to the right from the right side surface of the housing 71 and has a shape of a flat plate whose plate thickness direction coincides with the up-down direction. A protruding part 78a protruding in the front-rear direction is provided at a distal end part of the moving-side abutment part 78.

The moving-side abutment part 78 is disposed below the coupling part 75 and is formed of a plate-shaped member such as a metal plate.

As described above, the abutment member 12 is provided on the upper part of the accommodation body 42. As shown in FIG. 5, the abutment member 12 is provided with a main-body-side abutment part 14 formed by bending at least a part of the abutment member 12 upward. The main-body-side abutment part 14 protrudes upward from the upper part of the accommodation body 42 and the abutment member 12, and is formed in the shape of a flat plate whose plate thickness direction coincides with the left-right direction. A protruding part 14a protruding in the front-rear direction is provided at a distal end part of the main-body-side abutment part 14.

The protruding part 14a of the main-body-side abutment part 14 is located above the moving-side abutment part 78. The protruding part 78a of the moving-side abutment part 78 is located to the right of the main-body-side abutment part 14. When the carriage 69 is located at the home position, the moving-side abutment part 78 of the irradiation unit 70 and the main-body-side abutment part 14 of the main body unit 10 overlap each other as viewed in a front view.

That is, when the carriage 69 is located at the home position, a part of the moving-side abutment part 78 and a part of the main-body-side abutment part 14 overlap each other in the front-rear direction. Thus, in the state where the carriage 69 is located at the home position, when the moving unit 50 moves in the front-rear direction, the carriage 69 moves in the front-rear direction and the moving-side abutment part 78 and the main-body-side abutment part 14 abut against each other at a predetermined position.

As described above, the main-body-side abutment part 14 is arranged such that the plate thickness direction thereof coincides with the left-right direction, and the moving-side abutment part 78 is arranged such that the plate thickness direction thereof coincides with the up-down direction. Therefore, when the moving-side abutment part 78 and the main-body-side abutment part 14 abut against each other, edge parts of the moving-side abutment part 78 and the main-body-side abutment part 14 come into contact with each other. Thus, in the printing device 1, even when the moving-side abutment part 78 presses the main-body-side abutment part 14 due to the movement of the carriage 69, the deformation of the moving-side abutment part 78 and the main-body-side abutment part 14 is suppressed.

Moreover, even when one of the moving-side abutment part 78 and the main-body-side abutment part 14 is shifted in position as the moving-side abutment part 78 presses the main-body-side abutment part 14 due to the movement of the carriage 69, the protruding part 14a or the protruding part 78a engages with the other. Therefore, in the printing device 1, the movement of either the moving-side abutment part 78 or the main-body-side abutment part 14 to a position where these parts do not abut against each other is suppressed.

FIG. 2 illustrates the carriage 69 in a state where the pressing part 77 is fitted in the first recess 66a. In the present embodiment, the relative position of the irradiation unit 70 with respect to the head 80 in this state is defined as a first relative position P1. When the irradiation unit 70 is located at the first relative position P1, the entire range in which the nozzle 83 of the head 80 is formed overlaps the irradiation port 71a as viewed in the left-right direction. When the irradiation unit 70 is located at the first relative position P1, the first guide pin 74a abuts against a first abutment surface 64b, which is the rear end of the guide hole 64a.

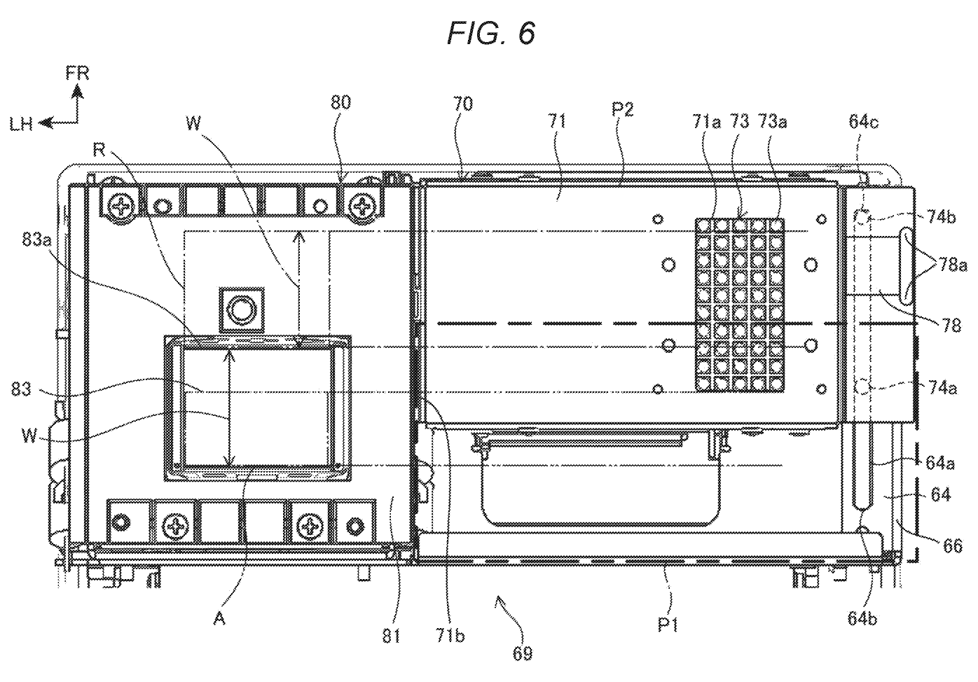

FIG. 6 is a plan view of the carriage 69. FIG. 6 shows the carriage 69 in the state where the pressing part 77 is fitted in the second recess 66b, as viewed from below. In the present embodiment, the relative position of the irradiation unit 70 with respect to the head 80 in the state illustrated in FIG. 6 is defined as a second relative position P2. When the irradiation unit 70 is located at the second relative position P2, at least a part of the irradiation port 71a is disposed at a position not overlapping a range A, which is a partial range of the range in which the nozzle 83 indicated by an imaginary line is formed as viewed from the left-right direction. When the irradiation unit 70 is located at the second relative position P2, at least a part of the irradiation port 71a overlaps an entire range R as viewed in the left-right direction. The range R is a range from a front end part 83a of the range in which the nozzle 83 is formed to a position separated forward from the end part 83a by a distance W. The distance W is equal to the dimension in the front-rear direction of the range in which the nozzle 83 is formed.

Also, when the irradiation unit 70 is located at the second relative position P2, the second guide pin 74b abuts against a second abutment surface 64c, which is the front end of the guide hole 64a.

When the printing device 1 executes a printing operation, the time from when the nozzle 83 ejects the ink to the medium M to when the ink attached to the medium M is irradiated with the ultraviolet rays from the irradiation port 71a influences the finish of printing. In the present embodiment, this time is temporarily referred to as a pre-irradiation time. When the pre-irradiation time is long, the ink attached to the surface of the medium M spreads in a wet state and is smoothed on the surface of the medium M before being cured by irradiation with ultraviolet rays. Therefore, the gloss of the printed part becomes stronger as the pre-irradiation time becomes longer. Meanwhile, when the pre-irradiation time is short, the ink attached to the surface of the medium M does not sufficiently spread in a wet state and is cured in an unsmoothed state. Therefore, when the pre-irradiation time is short, the state where the unevenness remains on the surface of the ink is fixed, and thus the gloss is weakened. The pre-irradiation time varies depending on the positional relationship between the nozzle 83 and the irradiation port 71a. When the printing device 1 executes printing when the irradiation unit 70 is located at the first relative position P1, the pre-irradiation time is short and therefore the printed object has a matte finish with weak gloss. In other words, the printing device 1 executes the matte printing by executing the printing with the irradiation unit 70 located at the first relative position P1. Also, the printing device 1 executes glossy printing with high gloss by executing printing when the irradiation unit 70 is located at the second relative position P2. Details of the printing operation of the printing device 1 will be described later.

### 1.3. Configuration of Control System of Printing Device

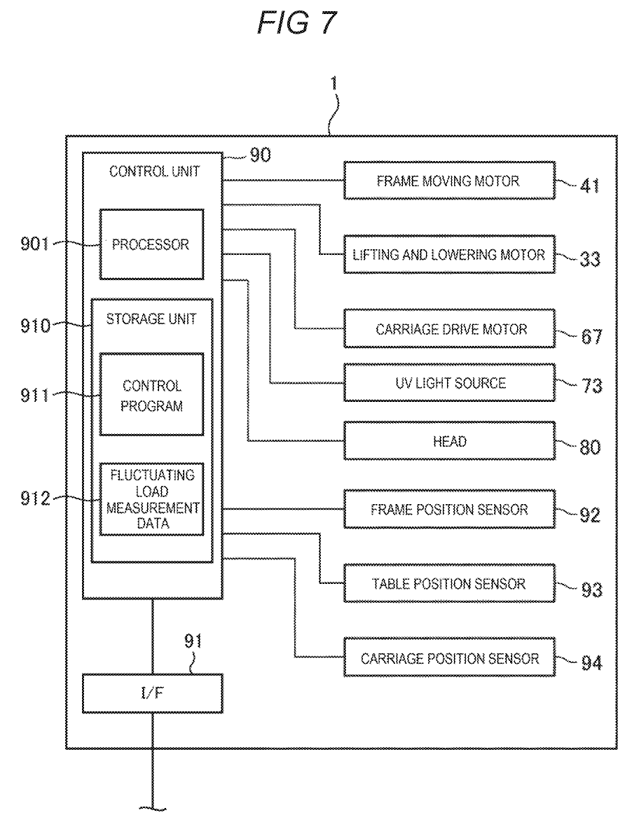

FIG. 7 is a block diagram showing the functional configuration of the control system of the printing device 1.

The printing device 1 includes the control unit 90. The control unit 90 includes a processor 901 configured with a central processing unit (CPU), a micro-processing unit (MPU) or the like, and a storage unit 910. The storage unit 910 includes a volatile memory and a nonvolatile storage unit. The volatile memory is, for example, a RAM (random-access memory). The nonvolatile storage unit includes a read-only memory (ROM), a hard disk, a flash memory, and the like. The control unit 90 executes a control program 911 stored in the storage unit 910 and thus controls each part of the printing device 1.

An interface (I/F) 91 is coupled to the control unit 90. The interface 91 is a communication device that executes wired communication using a cable or wireless communication using a wireless communication line. The interface 91 executes communication with a host computer provided outside the printing device 1 and receives print data. The print data includes data of an image or a character to be printed on the medium M by the printing device 1, a command for instructing the printing device 1 to execute printing, and other data.

The lifting and lowering motor 33, the frame moving motor 41, the carriage drive motor 67, the UV light source 73, and the head 80 are coupled to the control unit 90. A frame position sensor 92, a table position sensor 93, and a carriage position sensor 94 are coupled to the control unit 90.

The control unit 90 can acquire current values applied to the lifting and lowering motor 33, the frame moving motor 41, and the carriage drive motor 67. The control unit 90 detects loads applied to the lifting and lowering motor 33, the frame moving motor 41, and the carriage drive motor 67 from the acquired current values.

The control unit 90 controls the turning on and off of the UV light source 73. The control unit 90 can control the turning on and off of the light emitting elements 73a forming the UV light source, for each line of the light-emitting elements 73a arranged in the front-rear direction. The control unit 90 may adjust the light emission intensity by adjusting the current supplied to each of the light emitting elements 73a or each line.

The frame position sensor 92 is a sensor that detects the position of the main frame 51 in the front-rear direction. For example, the frame position sensor 92 is a linear encoder disposed along the guide shaft 15. The table position sensor 93 is a sensor that detects the position of the table 31 in the up-down direction. The table position sensor 93 is, for example, a rotary encoder that detects the amount of rotation of the lifting and lowering motor 33 or a rotary encoder that detects the amount of rotation of the ball screw of the lifting and lowering mechanism 39. The carriage position sensor 94 is a sensor that detects the position of the carriage 69 in the longitudinal direction of the carriage guide shaft 63. For example, the carriage position sensor 94 is a linear encoder disposed along the carriage guide shaft 63. The control unit 90 specifies the position of the main frame 51, the position of the table 31, and the position of the carriage 69, based on the detection values of the frame position sensor 92, the table position sensor 93, and the carriage position sensor 94.

The frame position sensor 92 is an example of a "position detection unit".

The control unit 90 causes each motor to operate, based on the print data received by the interface 91. Specifically, the control unit 90 controls the switching of the direction of rotation of the frame moving motor 41 and the start and stop of the rotation of the frame moving motor 41 and thus causes the moving unit 50 to move forward and backward. The control unit 90 controls the switching of the direction of rotation of the lifting and lowering motor 33 and the start and stop of the rotation of the lifting and lowering motor 33 and thus causes the table 31 to move in the up-down direction. The control unit 90 controls the switching of the carriage drive motor 67 and the start and stop of the rotation of the carriage drive motor 67 and thus causes the carriage 69 to move along the carriage guide shaft 63. In these controls, the control unit 90 uses detection values of the frame position sensor 92, the table position sensor 93, and the carriage position sensor 94.

The control unit 90 switches the relative position of the irradiation unit 70 with respect to the head 80 according to fluctuating load measurement data 912. The fluctuating load measurement data 912 includes data for determining a position where the current value of the frame moving motor 41 is measured, according to whether the printing mode of the printing device 1 is glossy printing or matte printing.

For example, when matte printing is performed, the fluctuating load measurement data 912 designates a position where the current value of the frame moving motor 41 is acquired, in the range where the main frame 51 is movable. The position includes, for example, a first reference position and a first measurement position.

The first reference position is a position to the rear of the main-body-side abutment part 14 and closer to the main-body-side abutment part 14 than the rear end part of the guide shaft 15, in the range where the main frame 51 is movable.

The first measurement position is a position to the front of the position where the moving-side abutment part 78 abuts against the main-body-side abutment part 14 from the rear.

In the description below, the current value acquired at the first reference position is referred to as a first reference current value, and the current value acquired at the first measurement position is referred to as a first measured current value.

Also, for example, the fluctuating load measurement data 912 designates a position where the current value of the frame moving motor 41 is acquired, in the range where the main frame 51 is movable, when glossy printing is performed. The position includes, for example, a second reference position and a second measurement position.

The second reference position is a position to the front of the main-body-side abutment part 14 and closer to the main-body-side abutment part 14 than the front end part of the guide shaft 15, in the range where the main frame 51 is movable.

The second measurement position is a position to the rear of the position where the moving-side abutment part 78 abuts against the main-body-side abutment part 14 from the front.

In the description below, the current value acquired at the second reference position is referred to as a second reference current value, and the current value acquired at the second measurement position is referred to as a second measured current value.

The fluctuating load measurement data 912 includes current value data to be compared with the difference value between the acquired current values according to whether the printing mode of the printing device 1 is glossy printing or matte printing.

For example, the fluctuating load measurement data 912 may include a first comparative current value to be compared with the difference value between the current value acquired at the first reference position and the current value acquired at the first measurement position when matte printing is performed. The first comparative current value is a current value input to the frame moving motor 41 when the irradiation unit 70 moves from the second relative position P2 to the first relative position P1.

Also, for example, the fluctuating load measurement data 912 may include a second comparative current value to be compared with the difference value between the current value acquired at the second reference position and the current value acquired at the second measurement position when glossy printing is performed. The second comparative current value is a current value input to the frame moving motor 41 when the irradiation unit 70 moves from the first relative position P1 to the second relative position P2.

Also, for example, the control unit 90 may specify and store which position of the first relative position P1 and the second relative position P2 the irradiation unit 70 is disposed at, based on the detection value of the frame position sensor 92.

The control unit 90 causes the head 80 to operate and thus eject the ink, based on the print data received by the interface 91.

### 1.4. Operation of Printing Device

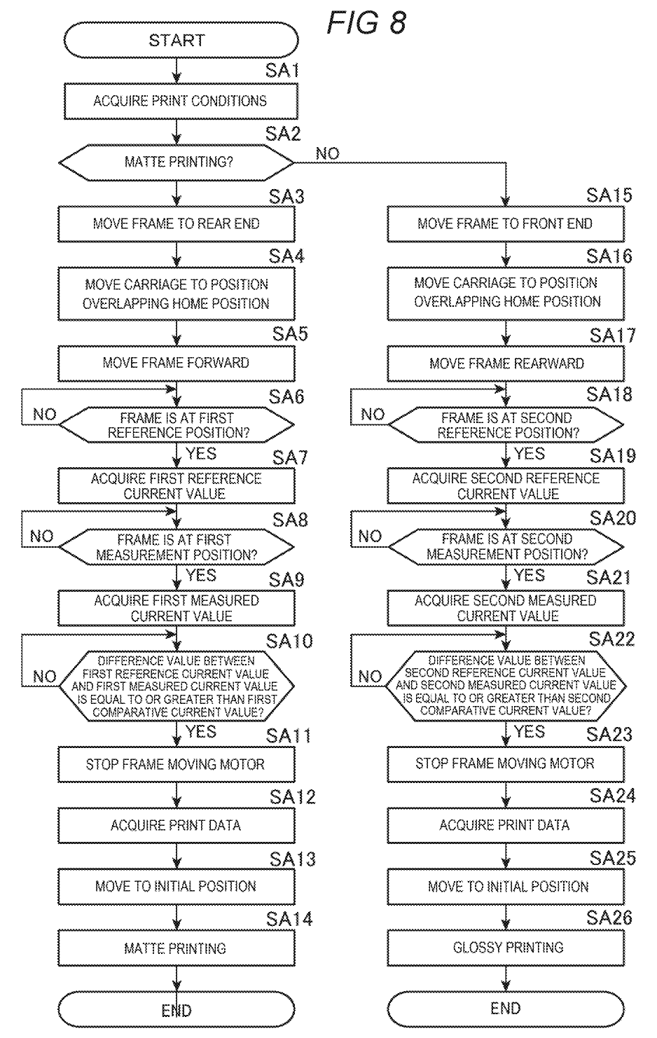

FIG. 8 is a flowchart showing the operation when the control unit 90 executes printing.

At the time point when the printing device 1 starts the printing operation, the irradiation unit 70 is located at the first relative position P1 as illustrated in FIG. 2. At the time point when the printing device 1 starts the printing operation, the carriage 69 is located at the home position and the main frame 51 is located at the front end part. Also, at the time point when the printing device 1 starts the printing operation, the distance between the nozzle 83 and the medium M is in a state of being adjusted to be an optimal distance for printing, by the up-down movement of the table 31.

The control unit 90 acquires print conditions (step SA1). The print conditions include, for example, information for designating whether the printing on the medium M is matte printing or glossy printing, information on the number of print paths, and information on the moving speed of the carriage 69. For example, the print conditions are added to print data including an image or a character to be printed on the medium M, or are included in the print data. For example, in step SA1, the control unit 90 acquires the print conditions from the print data received by the interface 91.

The control unit 90 determines whether to execute matte printing, based on the print conditions acquired in step SA1 (step SA2). When it is determined that matte printing is to be executed (YES in step SA2), the control unit 90 drives the frame moving motor 41 to move the main frame 51 to the rear end part of the guide shaft 15 (step SA3). The control unit 90 drives the carriage drive motor 67 to move the carriage 69 to a position overlapping the home position as viewed in a front view (step SA4). Thus, the moving-side abutment part 78 of the irradiation unit 70 and the main-body-side abutment part 14 of the main body unit 10 are located at positions overlapping each other in the front-rear direction. The main-body-side abutment part 14 is located to the front of the moving-side abutment part 78. Note that, as long as the main-body-side abutment part 14 is located to the front of the moving-side abutment part 78, the main frame 51 may not be moved to the rear end part of the guide shaft 15 in step SA3.

The control unit 90 drives the frame moving motor 41 to start moving the main frame 51 forward (step SA5). When the main frame 51 moves forward, the moving-side abutment part 78 similarly moves forward.

Subsequently, the control unit 90 determines whether the main frame 51 reaches the first reference position, based on the detection value of the frame position sensor 92 (step SA6). When it is determined that the main frame 51 reaches the first reference position (YES in step SA6), the control unit 90 acquires the first reference current value (step SA7).

Subsequently, the control unit 90 determines whether the main frame 51 reaches the first measurement position, based on the detection value of the frame position sensor 92 (step SA8). In this case, the control unit 90 may move the main frame 51 forward in accordance with the position of the main frame 51.

Here, as the main frame 51 moves forward, the moving-side abutment part 78 abuts against the main-body-side abutment part 14 from the rear.

Due to this abutment, a drag from the front to the rear is applied to the moving-side abutment part 78. Immediately after the moving-side abutment part 78 and the main-body-side abutment part 14 abut against each other, the drag acting on the moving-side abutment part 78 is small.

For example, when the pressing part 77 is fitted in the second recess 66b, the pressing part 77 does not immediately come off the second recess 66b, and the irradiation unit 70 remains at the second relative position P2. When the frame moving motor 41 continues to be driven from this state, the drag applied to the moving-side abutment part 78 gradually increases and the load on the frame moving motor 41 increases. As the drag applied to the moving-side abutment part 78 increases, the pressing part 77 comes off the second recess 66b, the irradiation unit 70 starts moving rearward relative to the head 80, and the fluctuation of the load on the frame moving motor 41 decreases. When the main frame 51 moves further forward, the pressing part 77 fits into the first recess 66a, the load on the frame moving motor 41 decreases, and the first guide pin 74a abuts against the first abutment surface 64b. When the frame moving motor 41 continues to be driven even after the first guide pin 74a abuts against the first abutment surface 64b, the load on the frame moving motor 41 increases. Thus, the irradiation unit 70 is fixed at the first relative position P1. That is, the irradiation unit 70 moves rearward relative to the head 80 when the carriage 69 moves forward in the state where the moving-side abutment part 78 and the main-body-side abutment part 14 abut against each other.

When the pressing part 77 is fitted in the first recess 66a and the first guide pin 74a abuts against the first abutment surface 64b, the drag applied to the moving-side abutment part 78 is transmitted to the frame moving motor 41 as a load. The control unit 90 can acquire the value of the current flowing through the frame moving motor 41 and thus can specify an increase or decrease in the load due to the transmitted drag.

When it is determined that the main frame 51 reaches the first measurement position (YES in step SA8), the control unit 90 acquires the first measured current value (step SA9).

When the irradiation unit 70 moves from the second relative position P2 to the first relative position P1, the control unit 90 stores the first comparative current value as the value of the current that can flow through the frame moving motor 41. The control unit 90 determines whether the difference value between the first reference current value and the first measured current value is equal to or greater than the first comparative current value (step SA10).

When it is determined that the difference value between the first reference current value and the first measured current value is smaller than the first comparative current value (NO in step SA10), the control unit 90 determines that the pressing part 77 is not fitted in the first recess 66a, and continues to move the main frame 51 forward.

When it is determined that the difference value between the first reference current value and the first measured current value is equal to or greater than the first comparative current value (YES in step SA10), the control unit 90 determines that the pressing part 77 is fitted in the first recess 66a, and stops the frame moving motor 41 (step SA11).

Next, the control unit 90 acquires print data (step SA12), and moves each part of the control unit 90 to an initial position (step SA13). The initial position is a position taken when printing on the medium M is started. Next, the control unit 90 executes matte printing, based on the print data (step SA14).

In this way, by measuring the fluctuation of the load in the frame moving motor 41, the control unit 90 can determine the relative position of the irradiation unit 70 with respect to the head 80 without having a sensor or the like that detects the position of the irradiation unit 70 in the carriage 69. Moreover, the control unit 90 can suppress an unnecessary increase in the load applied to each of the drive units driving the carriage 69 and the main frame 51, when the irradiation unit 70 moves relative to the head 80. In addition, the control unit 90 can reduce the amount of power input to the frame moving motor 41.

In the present embodiment, the control unit 90 may execute steps SA3 to SA11 even when the pressing part 77 is fitted in the first recess 66a.

Also, for example, the control unit 90 may store whether the irradiation unit 70 is disposed at the first relative position P1 or the second relative position P2. In such a case, the control unit 90 may omit steps SA3 to SA11, for example, when matte printing is performed in the state where the pressing part 77 is fitted in the first recess 66a.

When it is determined that glossy printing is to be executed (NO in step SA2), the control unit 90 drives the frame moving motor 41 to move the main frame 51 to the front end part of the guide shaft 15 (step SA15). The control unit 90 drives the carriage drive motor 67 to move the carriage 69 to a position overlapping the home position as viewed in a front view (step SA16).

Thus, the moving-side abutment part 78 of the irradiation unit 70 and the main-body-side abutment part 14 of the main body unit 10 are disposed at positions overlapping each other in the front-rear direction. The main-body-side abutment part 14 is located to the rear of the moving-side abutment part 78. Note that, as long as the main-body-side abutment part 14 is located to the rear of the moving-side abutment part 78, the main frame 51 may not be moved to the front end part of the guide shaft 15 in step SA15.

The control unit 90 drives the frame moving motor 41 to start moving the main frame 51 rearward (step SA17).

Subsequently, the control unit 90 determines whether the main frame 51 reaches the second reference position, based on the detection value of the frame position sensor 92 (step SA18). When it is determined that the main frame 51 reaches the second reference position (YES in step SA18), the control unit 90 acquires the second reference current value (step SA19).

Subsequently, the control unit 90 determines whether the main frame 51 reaches the second measurement position, based on the detection value of the frame position sensor 92 (step SA20). In this case, the control unit 90 may move the main frame 51 rearward in accordance with the position of the main frame 51.

Here, as the main frame 51 moves rearward, the moving-side abutment part 78 abuts against the main-body-side abutment part 14 from the front.

Due to this abutment, a drag from the rear to the front is applied to the moving-side abutment part 78. Immediately after the moving-side abutment part 78 and the main-body-side abutment part 14 abut against each other, the drag acting on the moving-side abutment part 78 is small.

For example, when the pressing part 77 is fitted in the first recess 66a, the pressing part 77 does not immediately come off the first recess 66a, and the irradiation unit 70 remains at the first relative position P1. When the frame moving motor 41 continues to be driven from this state, the drag applied to the moving-side abutment part 78 gradually increases and the load on the frame moving motor 41 increases. As the drag applied to the moving-side abutment part 78 increases, the pressing part 77 comes off the first recess 66a, the irradiation unit 70 starts moving forward relative to the head 80, and the fluctuation of the load on the frame moving motor 41 decreases. When the main frame 51 moves further to the rear, the pressing part 77 fits into the second recess 66b, the load on the frame moving motor 41 decreases, and the second guide pin 74b abuts against the second abutment surface 64c. When the frame moving motor 41 continues to be driven even after the second guide pin 74b abuts against the second abutment surface 64c, the load on the frame moving motor 41 increases.

Thus, the irradiation unit 70 is fixed at the second relative position P2. That is, the irradiation unit 70 moves forward relative to the head 80 when the carriage 69 moves rearward in the state where the moving-side abutment part 78 and the main-body-side abutment part 14 abut against each other.

When the pressing part 77 is fitted in the second recess 66b and the second guide pin 74b abuts against the second abutment surface 64c, the drag applied to the moving-side abutment part 78 is transmitted to the frame moving motor 41 as a load. The control unit 90 can acquire the value of the current flowing through the frame moving motor 41 and thus can specify an increase or decrease in the load due to the transmitted drag.

When it is determined that the main frame 51 reaches the second measurement position (YES in step SA20), the control unit 90 acquires the second measured current value (step SA21).

When the irradiation unit 70 moves from the first relative position P1 to the second relative position P2, the control unit 90 stores the second comparative current value as the value of the current that can flow through the frame moving motor 41. The control unit 90 determines whether the difference value between the second reference current value and the second measured current value is equal to or greater than the second comparative current value (step SA22).

When it is determined that the difference value between the second reference current value and the second measured current value is smaller than the second comparative current value (NO in step SA22), the control unit 90 determines that the pressing part 77 is not fitted in the second recess 66b, and continues to move the main frame 51 rearward.

When it is determined that the difference value between the second reference current value and the second measured current value is equal to or greater than the second comparative current value (YES in step SA22), the control unit 90 determines that the pressing part 77 is fitted in the second recess 66b, and stops the frame moving motor 41 (step SA23).

Next, the control unit 90 acquires print data (step SA24), and moves each part of the control unit 90 to the initial position (step SA25). Next, the control unit 90 executes glossy printing, based on the print data (step SA26).

In the printing device 1, when the main frame 51 moves forward, the bent parts of the ink tubes 19 coupled to the carriage 69 extend. When the main frame 51 moves rearward, each of the ink tubes 19 is bent so as to be folded.

Therefore, in the printing device 1, the load applied to the frame moving motor 41 due to the elastic force of the ink tubes 19 is different between when the main frame 51 moves forward and when the main frame 51 moves rearward. Also, when the main frame 51 moves from one side to the other side in the entire range where the main frame 51 is movable, various load elements are added and therefore it is difficult to distinguish which load element causes the fluctuation of the load.

In the present embodiment, the control unit 90 measures each of the first reference current value, the second reference current value, the first measured current value, and the second measured current value. The control unit 90 compares the difference value between the first reference current value and the first measured current value or the difference value between the second reference current value and the second measured current value with the first comparative current value or the second comparative current value.

Thus, the control unit 90 can more accurately determine the position of the irradiation unit 70, based on the current value in both cases where the irradiation unit 70 moves from the first relative position P1 to the second relative position P2 and where the irradiation unit 70 moves from the second relative position P2 to the first relative position P1. Therefore, in the printing device 1, when the irradiation unit 70 moves relative to the head 80, an unnecessary increase in the load applied to each of the drive units driving the carriage 69 and the main frame 51 can be suppressed.

In addition, in the printing device 1, the first reference position is a position next to the first measurement position, and the second reference position is a position next to the second measurement position. Thus, in the printing device 1, the load can be measured in a range in which the load fluctuation due to load elements other than the irradiation unit 70 is relatively small. Therefore, in the printing device 1, the influence of the amount of fluctuation in the current value caused by the movement of the main frame 51 on the difference value between the first reference current value and the first measured current value or the difference value between the second reference current value and the second measured current value can be reduced. Therefore, in the printing device 1, the position of the irradiation unit 70 can be accurately determined, based on the current value in both cases where the irradiation unit 70 moves from the first relative position P1 to the second relative position P2 and where the irradiation unit 70 moves from the second relative position P2 to the first relative position P1.

The above-described embodiment is simply an example of one aspect of the present disclosure and can be freely modified and applied without departing from the scope and spirit of the present disclosure.

In the above-described embodiment, the control unit 90 acquires the current value of the frame moving motor 41 at the predetermined position. In this case, the control unit 90 may continue the measurement of the current value of the frame moving motor 41 started at the predetermined position, until a predetermined time elapses. Then, the control unit 90 may acquire the average value or the maximum value of the measurement values measured within the predetermined time, as the current value at the predetermined position.

The processor 901 may be configured with a single processor or may be configured with a plurality of processors. These processors may be hardware programmed to implement the corresponding functional units. That is, these processors may be configured with, for example, an application-specific integrated circuit (ASIC), a field-programmable gate array (FPGA) or the like.

The configuration of each unit of the printing device 1 in FIG. 7 is an example, and the specific implementation form thereof is not particularly limited. That is, pieces of hardware individually corresponding to the units need not necessarily be installed, and one processor can be configured to execute a program to implement the functions of the units. Also, some of the functions implemented by software in the above-described embodiment may be implemented by hardware, or some of the functions implemented by hardware may be implemented by software.

The steps of the operation illustrated in FIG. 8 are provided by dividing the operation according to the main processing content in order to facilitate the understanding of the operation, and the operation is not limited by the way the processing units are divided and the names thereof. The operation may be divided into more steps according to the processing content. The operation may also be divided such that one step includes more processing. Also, the order of the steps may be changed appropriately without departing from the spirit and scope of the present disclosure.

The directions such as the horizontal direction and the vertical direction and the various shapes in the above-described embodiment include an equivalent range that achieves the same functions and advantages as those of the directions and shapes unless otherwise specified.

### Summary of Present Disclosure

The present disclosure will be summarized below as appendices.

### Appendix 1

A printing device includes: a head that ejects a liquid which is cured when irradiated with an electromagnetic wave; a carriage that supports the head and is movable in a scanning direction; a moving unit configured to be able to move the carriage in an intersecting direction intersecting the scanning direction; an electromagnetic wave irradiation unit that is installed in the carriage in a state of being displaceable to a first relative position and a second relative position along the intersecting direction with respect to the head and emits the electromagnetic wave; a main-body-side abutment part that displaces the electromagnetic wave irradiation unit to any one of the first relative position and the second relative position by coming into contact with the electromagnetic wave irradiation unit; a drive unit that moves the moving unit along the intersecting direction; and a control unit that controls the drive unit, and the control unit determines that the electromagnetic wave irradiation unit is located at the first relative position or the second relative position, due to a load fluctuation in the drive unit.

Thus, in the printing device, the position can be determined with a simple device configuration in which a sensor or the like is not provided.

### Appendix 2

The printing device according to Appendix 1 further includes a position detection unit that detects a position of the moving unit, and the control unit determines that the electromagnetic wave irradiation unit is located at the first relative position or the second relative position, due to a load fluctuation in the drive unit after a position where the moving unit abuts against the main-body-side abutment part.

Thus, in the printing device, the determination accuracy can be improved by limiting the monitoring range of the load fluctuation.

### Appendix 3

In the printing device according to Appendix 1 or 2, the control unit determines that the electromagnetic wave irradiation unit is located at the first relative position or the second relative position, based on an increase in a load of the drive unit after a position where the moving unit abuts against the main-body-side abutment part.

Thus, as an increase in the load is detected, it can be determined that the engagement part is engaged, and there is no need to apply an excessive load.

### Appendix 4

In the printing device according to any one of Appendices 1 to 3, one of the carriage and the electromagnetic wave irradiation unit is provided with a recess at least at one of the first relative position and the second relative position, and the other is provided with a protrusion engaged with the recess.

Thus, the electromagnetic wave irradiation unit can be easily moved to the first relative position or the second relative position.

### Appendix 5

In the printing device according to Appendix 4, the protrusion is configured to be displaceable between an engaged state and a non-engaged state with respect to the recess as the moving unit moves in the intersecting direction in a state where the electromagnetic wave irradiation unit abuts against the main-body-side abutment part.

Thus, the displacement between the first relative position and the second relative position can be easily performed.

### Appendix 6

In the printing device according to any one of Appendices 1 to 5, the electromagnetic wave irradiation unit includes a moving-side abutment part that abuts against the main-body-side abutment part at any position in the intersecting direction, the main-body-side abutment part and the moving-side abutment part extend in a direction intersecting the intersecting direction, and a protruding part extending along the intersecting direction is provided at least at one of the main-body-side abutment part and the moving-side abutment part.

Thus, in the printing device, the movement of either the moving-side abutment part or the main-body-side abutment part to a position where these parts do not abut against each other is suppressed.

What is claimed is:

1. A printing device comprising:
a head configured to eject a liquid which is cured when irradiated with an electromagnetic wave;
a carriage configured to support the head and be movable in a scanning direction;
a moving unit configured to move the carriage in an intersecting direction intersecting the scanning direction;
an electromagnetic wave irradiation unit installed in the carriage in a state of being displaceable to a first relative position and a second relative position along the intersecting direction with respect to the head and configured to emit the electromagnetic wave;
a main-body-side abutment part configured to displace the electromagnetic wave irradiation unit to any one of the first relative position and the second relative position by coming into contact with the electromagnetic wave irradiation unit;
a drive unit configured to move the moving unit along the intersecting direction; and
a control unit configured to control the drive unit, wherein
the control unit determines that the electromagnetic wave irradiation unit is located at the first relative position or the second relative position, due to a load fluctuation in the drive unit.

2. The printing device according to claim 1, further comprising
a position detection unit configured to detect a position of the moving unit, wherein
the control unit determines that the electromagnetic wave irradiation unit is located at the first relative position or the second relative position, due to a load fluctuation in the drive unit after a position where the moving unit abuts against the main-body-side abutment part.

3. The printing device according to claim 1, wherein
the control unit determines that the electromagnetic wave irradiation unit is located at the first relative position or the second relative position, based on an increase in a load of the drive unit after a position where the moving unit abuts against the main-body-side abutment part.

4. The printing device according to claim 1, wherein
one of the carriage and the electromagnetic wave irradiation unit is provided with a recess at least at one of the first relative position and the second relative position, and
the other is provided with a protrusion engaged with the recess.

5. The printing device according to claim 4, wherein
the protrusion is configured to be displaceable between an engaged state and a non-engaged state with respect to the recess as the moving unit moves in the intersecting direction in a state where the electromagnetic wave irradiation unit abuts against the main-body-side abutment part.

6. The printing device according to claim 1, wherein
the carriage is provided with a first engagement part at least at one of the first relative position and the second relative position, and
the electromagnetic wave irradiation unit is provided with a second engagement part engaged with the first engagement part.

7. The printing device according to claim 6, wherein
the second engagement part is configured to be displaceable between an engaged state and a non-engaged state with respect to the first engagement part as the moving unit moves in the intersecting direction in a state where the electromagnetic wave irradiation unit abuts against the main-body-side abutment part.

8. The printing device according to claim 6, wherein
the first engagement part is a recess, and
the second engagement part is a protrusion.

9. The printing device according to claim 1, wherein
the electromagnetic wave irradiation unit includes a moving-side abutment part that abuts against the main-body-side abutment part at any position in the intersecting direction,
the main-body-side abutment part and the moving-side abutment part extend in a direction intersecting the intersecting direction, and
a protruding part extending along the intersecting direction is provided at least at one of the main-body-side abutment part and the moving-side abutment part.
